(19) United States
(12) Patent Application Publication
(10) Pub. No.: US 2023/0256373 A1
(43) Pub. Date: Aug. 17, 2023

(54) VEHICLE CABIN AIR FILTER MONITORING SYSTEM

(71) Applicant: 3M INNOVATIVE PROPERTIES COMPANY, St. Paul, MN (US)

(72) Inventors: Justin M. Johnson, Hudson, WI (US); Gary G. Uebel, River Falls, WI (US); Reya Magan, Medina, MN (US); William K. Preska, Woodbury, MN (US); Abby R. Lemon, Vadnais Heights, MN (US)

(21) Appl. No.: 18/017,373

(22) PCT Filed: Jul. 26, 2021
(86) PCT No.: PCT/IB2021/056778

§ 371 Date: Jan. 20, 2023

Related U.S. Application Data
(60) Provisional application No. 62/706,020, filed on Jul. 27, 2020.

(51) Int. Cl. B01D 46/00; B60H 3/06

(52) U.S. Cl. CPC B01D 46/0086; B60H 3/0616; B01D 2279/50

(57) ABSTRACT

A cabin air quality monitoring system including a communications interface configured to receive snapshot information representing in-cabin air quality of a vehicle, a memory configured to store the snapshot information received by the communications interface and a processing circuitry configured to batch the snapshot information stored to the memory to form batched snapshot information, to execute, using the batched snapshot information as an input, a trained machine learning model to obtain a model output that includes cabin air filter replacement information, and to transmit, via the communications interface, the model output to computing hardware of the vehicle.

### TECHNICAL FIELD

The present disclosure generally relates to the field of air filtering.

### BACKGROUND

The suspension of vehicle exhaust, industrial exhaust, fumes, dust, smoke, gases, fly ash, soot, smoke, aerosols, fumes, mists, condensing vapors, volatile organic compounds (VOCs), such as general VOCs (TVOCs) and/or targeted (specific VOCs), or other contaminants in air constitute particular matter (PM) that alters the air quality of the affected environment. Non-PM contaminants that diminish air quality include one or more of carbon monoxide (CO), lead, nitrogen oxides, ground-level ozone, or sulfur oxides. Air pollution by way of such PM and/or non-PM contaminants can be hazardous or harmful to the health of humans, animals, or plants in the environment. Year over year, an increasing number of deaths and incidences of disease are being attributed to air quality diminished by contaminants. To illustrate, the increasing awareness of outdoor PM counts particularly in highly populated areas, and more recently, pandemics such as the COVID-19 pandemic, online searches for the expression “respiratory health” have increased by more than 400% within the span of one year. An environment in which people are susceptible to exposure to air contaminants is in vehicle cabins, based on the amount of time that people spend in vehicles, and the air-polluted environments in which vehicles might be driven.

### SUMMARY

The present disclosure describes a connected and integrated vehicle cabin air quality system configured to measure various air quality metrics, to ingest relevant vehicle data, to interface (directly or indirectly) to cloud resources, and to provide unique data that conveys one or both of filter status and/or air quality metrics to the driver and/or other vehicle occupants. The systems of this disclosure may also provide other advanced feedback to the vehicle, and/or leverage the vehicle's infotainment system or other human-machine interface to provide such advanced feedback to the vehicle occupant(s).

In some examples, the systems of this disclosure are configured to customize one or both of the cabin air filter status information and/or a cabin air filter replacement prediction using a data driven approach. In some examples, the systems of this disclosure may generate personalized recommendations by executing a machine learning (ML) algorithm that outputs data that helps drivers select a particular cabin air filter to maximize in-vehicle respiratory safety and air quality based on various criteria (e.g., web-scraped geographical data, preference inputs, vehicle data, air quality sensor data, etc.). In this way, the systems of this disclosure provide connected safety solutions that avail of cloud computing capabilities to notify drivers of vehicle cabin air quality degradation (or risks thereof) that might warrant attention or alternatively, to automatically implement one or more remediation measures to mitigate or rectify the detected/predicted air quality degradation.

The systems of this disclosure provide improved cabin air filter monitoring capabilities to drivers by integrating the ability to process the monitored data into vehicle hardware. In some examples, the systems of this disclosure may display metrics such as an air quality delta (in-cabin vs. outside, for example) to indicate the effectiveness of the current filter, or the current PM2.5 or PM0.3 level of exposure in the vehicle cabin. The systems of this disclosure are scalable and can be applied in a filter technology-agnostic way. The systems of this disclosure provide potential safety improvements, by using data-driven analysis to implement passive and/or active approaches for filter replacement notifications that may safeguard the respiratory health and general wellbeing of the vehicle's occupants. The wellbeing of the occupants may be affected by a variety of in-cabin air conditions, such as pollutant contamination for prolonged periods of time, occupant cognitive ability due to air purity and visibility levels, etc. Passive intervention approaches of this disclosure include providing notifications via in-vehicle display systems (e.g, an in-vehicle infotainment system, a dashboard display, etc.) or notifications via mobile phone applications or web portals. Active intervention approaches of this disclosure include automatically controlling the vehicle's heating, ventilation, and air conditioning (HVAC) and/or cabin air filtration systems.

The systems of this disclosure may also provide improvements in terms of environmental impact. By implementing a true data-driven lifetime measurement and replacement schedule for the in-cabin air filter, the systems of this disclosure may maximize the use of the filter media, thereby reducing the waste produced if filters are replaced on a set time-based schedule before replacement is truly warranted. This environmental impact is particularly positive in the case of vehicles that are equipped with more advanced filters that include multiple layers of specialty materials for optimal filtering, and which may have a greater impact on the environment upon disposal.

The details of one or more examples of the disclosure are set forth in the accompanying drawings and in the description below. Other features, objects, and advantages of the disclosure will be apparent from the description and drawings, and from the claims.

### BRIEF DESCRIPTION OF THE DRAWINGS

FIG. 1 is a block diagram illustrating a system that includes components that perform the cabin air filter monitoring techniques of this disclosure.

FIG. 2 is a block diagram illustrating aspects of this disclosure according to which systems may leverage particle sensing through user and environmental inputs to emphasize detection of certain particles and pollutants inside a vehicle.

FIGS. 3A-3F are example decision trees for deriving different conclusions based on combinations of measured sensor data, vehicle configuration data and external data streams.

FIG. 4 is a block diagram illustrating a mechanism to detect illegal substances or driver impairment based on chemical detection that warns the occupants or inhibits the vehicle from moving through integration with vehicle's computing systems.

FIG. 5 illustrates a base use case of delta air quality determination, in accordance with aspects of this disclosure.

FIG. 6 illustrates aspects of this disclosure by which systems may optimize vehicle tuning parameters in the vehicle's electronic control unit (ECU) based on sensed conditions in vehicle and scraped from outside of the vehicle.

FIG. 7 illustrates techniques of this disclosure that enable in-cabin odor sensing.

FIG. 8 illustrates aspects of this disclosure directed to in-cabin ozone detection.

FIG. 9 illustrates techniques of this disclosure for measuring in-cabin presence of VOCs and other parameters (carbon monoxide, etc).

FIG. 10 illustrates techniques of this disclosure related to providing correlation of sun intensity (e.g., ultraviolet light intensity) to in-cabin air quality to provide occupant air quality assessment and cabin air filtration recommendations.

FIG. 11 illustrates aspects of this disclosure related to exhaust sensing.

FIG. 12 illustrates aspects of this disclosure that enable systems to automate air quality measures in multiple zones within a vehicle cabin to provide micro-environment improvements in air quality in order to achieve a normalized and improved cabin environment for the vehicle occupant(s).

### DETAILED DESCRIPTION

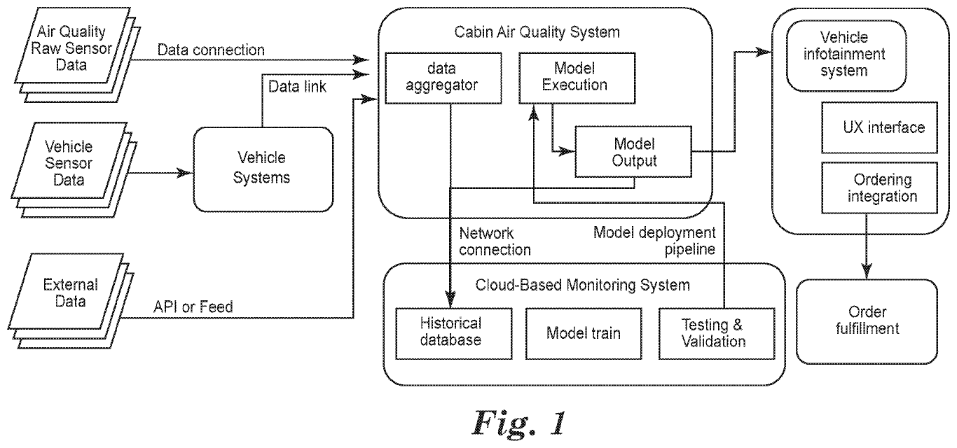

FIG. 1 is a block diagram illustrating a system that includes components that perform the cabin air filter monitoring techniques of this disclosure. The system of FIG. 1 is one non-limiting example of an implementation of the systems of this disclosure, and it will be appreciated that the systems of this disclosure are compatible with numerous other implementations. FIG. 1 is described by way of the example environment of an automobile cabin, although it will be appreciated that the systems of this disclosure may be configured to monitor air filter health and provide filter replacement recommendations for other environments, such as aircraft cabins, enclosed watercraft cabins, or any other space in which the local air quality might affect the health or wellbeing of people, animals, etc. PM and/or non-PM air contaminants can have non-health implications as well, such as fouling equipment or electrical components (e.g., HVAC equipment), and may pose a nuisance threat to certain machinery and equipment (e.g., HVAC systems, electronic in-vehicle equipment, etc.).

In general, the system of FIG. 1 provides data acquisition, monitoring, activity logging, reporting, predictive analytics, alert generation, and optionally, replacement/ordering with respect to the cabin air filter of a vehicle. The vehicle is equipped with one or more sensors configured to capture data pertaining to the functioning of the cabin air filter. Sensors are continually sensing the environment. Air quality sensors of FIG. 1 are directly connected to the cabin air quality system of the vehicle. Vehicle sensors of FIG. 1 read values and store the values to digital storage components of the vehicle systems shown in FIG. 1. External data sources illustrated in FIG. 1 represent sensor hardware and logic configured to continually collect data from a corresponding sensor network and store the collected data to one or more repositories for real-time, substantially real-time, or subsequent reference and potential usage for additional processing.

The cabin air quality system of FIG. 1 periodically collects snapshot information representing some or all of the data sources that are linked to the cabin air quality system. The cabin air quality system may access or receive the data of the snapshot information via one or more of several possible mechanisms including, but not limited to, a direct connection/link (either wired or wireless) to the air quality module, via a data link that conforms to one or more data transmission protocols, via an API function call, or through a subscription to a data feed or pipe.

The data aggregator of the cabin air quality system aggregates the snapshot data, and batches the data. The data aggregator may also perform any preprocessing (e.g., level normalization, unit conversion, translation, and the like) that might be necessary for further usage of the aggregated data. When in an idle state, the model execution module of the cabin air quality system ingests the data supplied from the data aggregator, and processes the data by executing a preformed model. The model execution module makes the resulting model output available upon completion of the execution phase of the model execution.

The cabin air quality system may continually, periodically, or on an ad hoc basis, transmit data to the cloud-based monitoring system of FIG. 1. In various examples, the cabin air quality system may transmit one or both of aggregated sensor data and/or model output data to the cloud-based monitoring system so as to provide a diversified data set for training purposes, as well as for storage to use as historical profile data for a given vehicle and/or air filter life (or predictions/projections thereof). The model training unit (“model train”) of the cloud-based monitoring system may access the collected data for one or more training phases of the model. The testing and validation unit of the cloud-based monitoring system may generate and output a detailed report to a vehicle owner either through a vehicle UI/UX or other interface (e.g., a smartphone screen or the like).

The model output is consumed by the vehicle infotainment system, where it may be stored along with other measurements and results to build a dataset that can be displayed through the vehicle human machine interface (HMI) or user interface (UI/UX) of the vehicle. In some examples, the systems of this disclosure may leverage in-vehicle connectivity to relay the data to another device equipped with an HMI, such as a smartphone. In some examples, the vehicle may be equipped with an integrated ordering mechanism or interface that enables a seamless user experience for ordering an appropriate replacement cabin air filter within a recommended time frame.

FIG. 1 illustrates an order fulfillment service that may process any orders received from the integrated ordering unit of the vehicle infotainment system, in those implementations of this disclosure in which the ordering unit is integrated into the vehicle and is activated. While FIG. 1 illustrates one possible embodiment of the system of this disclosure, it will be appreciated that other embodiments consistent with this disclosure may execute the model in the cloud and use the data link to transmit input data to the cloud/model and return resulting outputs to from the cloud to the vehicle infotainment system/HMI or other HMI (e.g., the HMI of a smartphone) that is communicatively coupled to an integrated computing system of the vehicle.

The systems of this disclosure may use one or more of a variety of data sources. Such data sources may include any data element that can be ingested into an algorithm or formula to determine or gauge cabin air quality and/or to predict filter status (e.g., current cabin air filter life and/or expected cabin air filter end of life, which indicate a time to replace the cabin air filter). The initial data elements may be drawn from one or more sources including sensor system data and/or vehicle data and/or external data.

As used herein, sensor system data may include any data that is generated by the air quality system package installed into the vehicle with a configuration or intended purpose of measuring cabin air quality. Examples sensors in this group include, but are not limited to, one or more of pressure sensors, volatile organic compound (VOC) sensors (for TVOC and/or specific VOC), carbon monoxide (CO) sensors, and exhaust sensors. These sensors often produce raw sensor values which can be directly utilized as inputs to various models (e.g., linear regression or any other model). These raw values can also be translated to human-readable data or data otherwise formatted in a human-understandable way within the cabin air quality sensor system in order to present this information via an HMI or other data reporting mechanisms.

The vehicle data as a data source may include any sensor data or data element that is generated by another system or function of the vehicle and made available through a data pipe or connection to the cabin air quality sensor system. One example of this data pipe is the OpenXC™ platform (http://openxcplatform.com/). Example vehicle data elements include vehicle speed, window state, HVAC state (e.g., mode, air output location, fresh/recirculate, etc.), HVAC fan speed, location as indicated by global positioning system (GPS) coordinates, in-cabin temperature, outside temperature, number of occupants, location of occupants, etc. In many examples, these data are represented by instantaneous values, and the cabin air quality system is configured to maintain historical values on various models. Available data may also vary depending on vehicle specifics such as make, model, model year, installed features, options included/excluded, trim level, etc.

External data as a data source encompasses any one or more of data provided by third parties, data scraped from the Internet, crowdsourced data available from other cabin air quality system users, and/or any data entered directly by the operator of the vehicle. Examples of data provided by third parties include external air quality data (e.g., as available from AirNow (https://www.airnow.gov/). Examples of web-scraped data include local weather data from sources such as Weather Underground (https://www.wunderground.com/) or weather.com (https://weather.com/). Another example is traffic data, such as data indicative of congestion and pollution as provided by some departments of transport (DOT) or third-party aggregators such as INRIX (https://inrix.com/) or Here Technologies (https://www.here.com/).

Many websites and third-party providers implement a toolset to perform a query of their data through a specialized interface, aiding in efforts to streamline data delivery. The cabin air quality sensor system of this disclosure may access the data directly if the model requires it in the execution phase, or the data may be integrated in the cloud-based monitoring system for training purposes, or both. These data sources provide rich environmental and location-specific data which can improve performance of the system by providing external benchmarks for metrics such as a delta air quality, which indicates a comparative score between in-cabin and outdoor air qualities. These metrics may, in some examples, be formed using a PM2.5 measurement, or any other air quality metrics that the cabin air quality sensor system is capable of calculating.

Data entered directly by a user can include personalized preferences or sensitivities that can be considered in forming the lifetime calculation for the cabin air filter. For example, allergy or asthma conditions pertaining to vehicle owners, operators, or known passengers may prompt a different lifetime calculation for the cabin air filter, in order to minimize exposure to triggering particles or other irritants for these sensitized individuals. In this way, the systems of this disclosure train the model, whether in an initial training phase or in a subsequent pass of training refinement to intelligently adjust filter performance minimum threshold levels.

As discussed above, the system of FIG. 1 incorporates functionalities to transmit the data collected from these sources to a cloud database (e.g, as implemented by the cloud-based monitoring system of FIG. 1). By maintaining a history log for each vehicle (e.g., in the historical database shown in FIG. 1), the cloud-based monitoring system enables more advanced algorithms for filter life and filter quality. The systems of this disclosure may implement different data transmission techniques depending on priorities, such as data integrity/richness/completeness, considerations of bandwidth and cost (both transmission and storage), resource expenditure, iteration metrics, etc. The data frequency and number of different parameters to send is a parameter which can be configured dynamically through model and data strategy updates either in a new configuration release/push, or through an automated data strategy based on a machine learning model that optimizes the input data requirements after learning and testing the impacts of different frequencies or inclusive data sets.

The systems of this disclosure may employ any of a number of different mechanism to connecting the air quality sensor system to the cloud. In one example, the system may leverage the vehicle's telemetry hardware to establish a data connection to transmit data to and receive data from the sensor system application via an encrypted or secured data path. In another example, the system may achieve cloud connectivity by leveraging an in-cabin connection (e.g., a Bluetooth® connection) to use one or more applications running on a vehicle occupant's smartphone, thereby using the smartphone as an intermediate device while leveraging the cellular data connection or other data connection of the smartphone.

In this example, the air quality sensor system transmits data via the Bluetooth® connection to the smartphone application, which then routes the data (either after preprocessing or in unchanged form) to the cloud-based monitoring system. In another example, the system achieves cloud connectivity by availing of the vehicle's Wi-Fi® connection. For example, when the vehicle connects to a wireless router when garaged or at another location with open wireless router availability, the computing hardware may pass data from the application through the wireless Internet connection to the cloud. Regardless of the cloud connectivity mechanism that is utilized, security, encryption and data integrity can be implemented and maintained on an as-needed basis or at all times, in various cases.

The application may maintain a connection to the cloud in order to utilize third party data in model execution and transfer aggregated data into the historical database of the cloud-based monitoring system, in some use case scenarios. The application may be resilient with respect to connectivity losses, by implementing the capability to store and forward data in a batched manner based on connectivity availability, connectivity bandwidth thresholds, etc. For instance, in areas of poor connectivity, or in cases of saving cellular data charges being a desirable outcome, the application may cache a known route or radius around a vehicle prior to leaving a Wi-Fi® connected area, and use the cached data during portions of the travel. As such, the systems of this disclosure may utilize cloud-computing capabilities whether or not data communication with the cloud in real-time or near real-time is available.

In some examples, to mitigate periods of no connectivity, the system of this disclosure may utilize average values for a given area to estimate certain values when near real-time data is unavailable. These estimates can be either preloaded from a third-party source for such a scenario, or may be collected as crowdsourced data from other vehicles in the same area over time in the online database. In some such cases, the systems of this disclosure may periodically refresh the collected data on the vehicle. These estimates are helpful in calculating exposure levels and filter lifetimes in cases where real-time data is unavailable.

In some examples, the systems of this disclosure may generate data (instead of or in addition to the sensor system) using a crowdsourced application. In this case, users could actively report or vehicle computing logic can passively report air conditions that affect the use of cabin air filters, such as the presence of smoke, chemical spills, or other environmental conditions which could lead to poor air quality as observed at traveled locations. Any output from the systems of this disclosure can be stored and relayed at a later time depending on connectivity and/or bandwidth considerations. Because these data are utilized for training models and/or improving trained models and for keeping historical records, the eventual storage is more important than the timeliness of the upload.

The cloud-based monitoring system implements various functionalities within the overall functioning of the system shown in FIG. 1. As one example, the cloud-based monitoring system provides a data store for cataloging and retrieving one or more of cabin air quality data, filter life data, model output, or any associated sensor data or other metadata. The database can also store other pertinent information such as geolocation, timestamp, lifetime predictions, etc., depending on the configuration of the system in a given use case scenario, availability of the data, etc. The cloud-based monitoring system also provides model training, testing, validation, and optimization, as well as version control, deployment pipeline, and deployment history. The cloud-based monitoring system may also host and support algorithm development functionalities. The strength of the dataset(s) available form the historical database enables evaluation of new models and drives the ability to apply machine learning and artificial intelligence to provide reliable outputs as solutions to complex problems.

Filter state and condition calculations enable the application to better measure cabin air filter effectiveness and provide more accurate predictions of time-to-change notifications for the cabin air filter media. Notifications are, in many scenarios, backed by data driven calculations and models rather than purely schedules and/or vehicle miles traveled (VMT). By leveraging a suite of sensor infrastructure, environmental conditions, and vehicle system data, the systems of this disclosure may generate a customized recommendation on when to replace the cabin air filter, and to inform users of the effectiveness of the cabin air filters. To provide these data driven recommendations and effectiveness scores, the systems of this disclosure may train models dynamically and test the models on real world data, depending on data availability.

An advantage of using a data driven approach to prompt cabin air filter replacement rather than a schedule is that data on filter quality has improved precision, and in some cases, more immediate understandability. In this way, the systems of this disclosure may log a filter's effectiveness decline over time and comparing that performance to other available filter media compatible with the same vehicle. Driving and storage condition differences directly correlate to measured filter lifetime, with filter media quality being a control condition. If filter replacement is performed purely on a time-based or mileage-based scheme, the data is imprecise in terms of the quality and efficacy of the filter media itself. The data categorization of this disclosure may potentially set apart high quality filter media from lower quality filter media, on the basis of performance. As, the models of this disclosure can be trained to recommend specific filters which have proven to have higher effectiveness or longer lifetime in similar driving conditions and/or environmental conditions as the candidate vehicle.

The user interfaces (UIs) of this disclosure function as the users' touch point for the overall system. The system uses the UI to output quality data, graphs, conclusions, and recommendations to users. In addition, the system may use the UI to enable users to input information and preferences into the system. One example of a user preference may be communicated by indicating allergies or chemical sensitivities as input data to the model, which the trained model could take into account to further customize and personalize the output.

The system may also use the UI to provide details about ordering replacement filters directly via the vehicle's HMI hardware, or via a another communicatively coupled device, such as a smartphone or tablet computer. The model may output filter suggestions that highlight the most suitable filters for the operating environment(s) at which the vehicle has been over the lifetime of the previous filter. Factors such as usage, geolocation, average exposures to different particulates or VOCs can also drive a more customized filter recommendation or filter selection option list (by constraining the list to viable or most pertinent options). The integrated ordering functionalities may follow a store-and-forward process to enable offline purchases as well. By creating this type of smooth user experience, in some cases supplemented with instructions on how to install the new filter upon delivery, the systems of this disclosure leverage UI functionalities of existing hardware to improve filter selection and installation faster and more effective.

The system may present data via the user interface to recommend actions based on the collected and analyzed sensor data. For example, the system may generate suggestions to close the windows of the vehicle, and/or to activate in-cabin air recirculation due to poor air quality outdoes (e.g., due to congestion on a machine-learned commute at a certain day/time), etc. In another example, the system may generate a suggestion to open the windows because of exhaust fumes detected in the cabin air sensor system, thereby aiding to disperse the exhaust fumes via air flow from the outside and the resulting ventilation.

In some examples, the systems of this disclosure may automate these suggestions by automatically implementing the suggestions via automated controls within the vehicle. In this case, for example, if the suggestion is to open the windows, the system may leverage the electronic window controls of the vehicle to automatically open one or more windows and/or the sunroof, and may provide a notification to explain the action taken. In some cases, in the event of a significant or serious problem with the cabin air filter status or the in-cabin air quality, the system may, in response to receiving certain cabin air quality sensor data, trigger a call to an automated support system (e.g. services provided by OnStar® or the like). For example, if CO is detected at or above a threshold quantity, the system may notify a safety support network to check whether the driver is responsive, thereby potentially averting additional dangerous situations. In some instances, the system may transmit data could be transmitted to support insurance claims or to justify repairs suggested by a mechanic or insurance adjuster.

The systems of this disclosure may customize the overall look, sound, and feel of the user interface based on the individual preferences. Data can be presented in different forms (e.g., graphs, percent, thresholded values, color-coded indicators, audio output via the vehicle's speaker system, or any other means) to convey the meaning, significance, and potential impact of the data being presented by the air quality sensor data and model output.

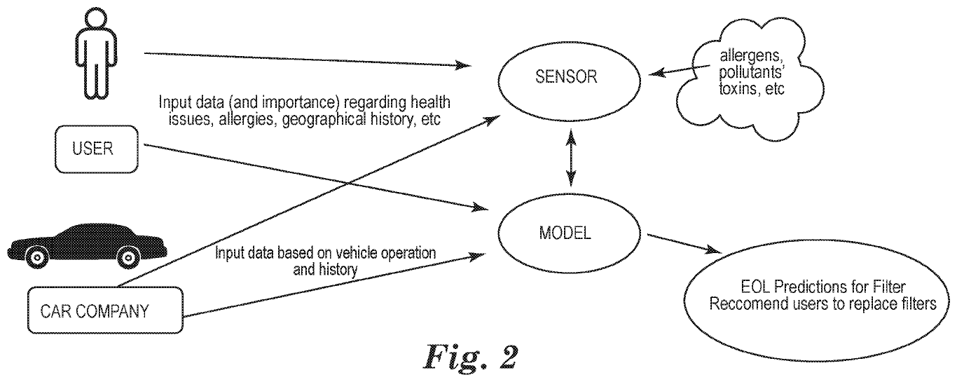

FIG. 2 is a block diagram illustrating aspects of this disclosure according to which systems may leverage particle sensing through user and environmental inputs to emphasize detection of certain particles and pollutants inside a vehicle. Using this data (and in some cases, a weighting of pollutants), systems of this disclosure may train a model to predict, relatively accurately, the end of life of a vehicle cabin air filter. In some cases, the trained model, during an execution phase, may output a recommendation to users to replace the cabin air filter with new cabin air filter media. By providing users the option to customize preferences based on health information and/or driving history, the sensor-based systems of this disclosure may provide alerts and/or suggestions that are customized/individualized to a given user or vehicle.

Systems of this disclosure are configured to improve air quality inside a vehicle by monitoring pollutant content and predicting end of life of cabin air filters. Air within automobiles can sometimes be fifteen times worse than the outside air quality. Outside pollutants often enter vehicles through air vents and then circulate through the vehicle cabin leading to heavy pollution inside. In some cases, allergens can also accumulate inside automobile cabins and can cause problems for those inside. Pollen, dust, and other common allergens can enter vehicles through open windows, clothes and footwear worn by occupants, etc. These allergens often go unnoticed. As such, this disclosure describes sensor technology programmed to detect such allergens and potentially enable users to replace cabin air filters promptly and/or otherwise clean their vehicles to address allergen-related issues. Systems of this disclosure may utilize one or more of environmental, geographical, and/or health data to detect pollutants and train a model to suggest filter replacement at appropriate times, thereby aiding in efforts that may lead to improved or consistently better air quality within vehicle cabins.

As described above, cabin air filters inside vehicles are generally replaced somewhat arbitrarily. For example, a user may replace the cabin air filter of a vehicle when the user notices the beginning or further progression of clogging up, or as a reaction to vehicle mileage reaching certain metrics. Filters can go months or even years without being replaced, leading to diminished air quality inside a vehicle cabin. Poor in-cabin air quality can negatively affect the health of drivers and passengers of the vehicle. Systems of this disclosure incorporate sensor technology programmed to detect pollutant content as inputted by users, thereby providing an enhanced, advanced end-of-life calculation for cabin air filters in comparison to techniques currently in use.

Instead of focusing on the temporal aspect of how long a filter has been in use, the systems of this disclosure provide users with more accurate predictions and reports that recommend replacing filters upon detecting or predicting high pollutant content (e.g., based on thresholding or other techniques). In some examples, the systems incorporate an autofill or order subscription service to aid in replacing cabin air filters in a timely and regular manner. Because the model of this disclosure uses machine learning to make individualized recommendations based on user experiences, recommendation accuracy is enhanced on a per-user or per-vehicle basis. The personalized sensor and model system lead to improved air quality within vehicle cabins, and caters to different users based on their health profiles, driving patterns, etc.

By having a cabin air quality system integrated into a vehicle, an operator can receive information indicating whether the cabin air filter is performing as expected by the manufacturer, and may potentially see live data about cabin air quality to both inform safety of breathing in the vehicle cabin as well as make informed cabin air filter replacement decisions related to the actual performance of any given cabin air filter in their vehicle. In some enhanced implementations, the model of this disclosure may be trained and executed to detect high dust/mold content and recommend the vehicle interior for deep cleaning along with recommending cabin air filter replacement. For user accessibility, the model may be trained and executed in such a way as to transmit these predictions and recommendations through infotainment systems integrated into the vehicle. In some examples, the techniques of this disclosure may equip the infotainment system of the vehicle to receive cabin air filter replacement orders from the user, and process these replacement orders partially or fully.

Usually, air filters are replaced depending on vehicle mileage (e.g. every 12,000 to 15,000 miles) or reductions in the efficiency of other car systems, and cabin air filter replacement does not utilize technology focused on intelligently determining the end of life or replacement of a cabin air filter. To improve recommendations and predictions for replacement and end of life of vehicle cabin air filters, the systems of this disclosure use customized or customizable sensors that use user inputs and/or environmental condition information. By using a broad set of collected and ingested vehicle and environmental data, as well as data collected from users and data relating to driving history, the systems of this disclosure may train the model to create relatively accurate predictive measures and to prompt users to replace cabin air filters.

The systems of this disclosure enable a combination of data to be fed into a model to produce a data-driven filter effectiveness score as well as an accurate lifetime prediction, thereby providing the vehicle operator with an accurate recommendation on when to replace the vehicle's cabin air filter. In training a model to predict end of life for filters, using customizable data may help to make accurate predictions on a case-by-case basis. Systems of this disclosure enable users to input personal data (e.g., information relating to respiratory problems or allergies), and may configure sensors to place priority weighting on particular pollutants/contaminants.

In this way, the systems of this disclosure may assign specific pollutants/contaminants given different weights based on user data, thereby providing a more representative end-of-life prediction for the cabin air filter in view of the particular user who relies on the cabin air filter. Additionally, in some embodiments, given travel history and geographical location, the systems of this disclosure may train the model to make accurate predictions based on common pollutants and their levels in those regions as well. One particular use case would leverage vehicle and user data along with predictive data to accurately determine the end of life of a cabin air filter, and prompt users to replace the cabin air filter. Again, FIG. 2 is an example of such an implementation of the systems of this disclosure.

Some examples of specific details and data combinations that contribute to the effectiveness calculation and lifetime prediction of filters are detailed below. One example is the geolocation of vehicle combined with road type information scraped from a department of transportation (DoT) or other local agency can create a score for what percentage of miles/time a vehicle travels on dirt or gravel roads. Another example is the geolocation of vehicle's base of operation (e.g. home address or garaging/parking location) combined with road types (e.g. paved, gravel, dirty) that exist within a predetermined radius, from which the trained model of this disclosure can create a weighted score of the likelihood that the vehicle will experience a higher degree or lower degree contamination, which the model may use in the end-of-life prediction of the cabin air filter media. Another example is a personalized model for the end of life of the cabin air filter media can, which the systems of this disclosure may develop dynamically with increasing levels of accuracy by considering patterns in driving routes and comparing these patterns to known and historical environmental conditions, such as one or more of road types, pollutant levels, atmospheric conditions, and the like.

In another example, the systems of this disclosure may initiate a personalized filter media end of life by using one or more types of seed data. In some examples, the seed data may represent one or more (e.g., a single one or any combination of) the primary user's home address or zip code, the general radius of operation/driving, the level of sensitivity to specific airborne contaminants, etc. In some examples, to execute the model more accurately in initial stages, the system may incorporate historical travel information from sources such as online maps and navigation services (e.g., as may be delivered to a driver via an in-built GPS system or a smartphone application that leverages the smartphone's GPS capabilities).

In some examples, the systems of this disclosure may scrape data relating to outdoor air quality or measure outdoor air quality, and compare the outdoor air quality data to in-cabin air quality data for any of the specific analytes or PM sizes can provide data points used to calculate cabin air filter effectiveness. These delta values may vary in accuracy based on certain vehicle conditions being met (e.g., all windows and sunroof are closed, fresh air or air conditioning is activated, etc). The vehicle's cabin creates a controlled micro-environment that has a known set of parameters that define the environment (e.g. volume, occupancy, HVAC air flow and filtration capacity, among other constants).

In some examples, the systems of this disclosure may combining this information with additional sensor data (e.g., temperature, particulate size, VOC levels, etc.) to potentially develop a model that accurately describes the environment and the level of filtration required to reach a “healthy” state of air quality in the cabin. In some examples, the systems of this disclosure may further combine this information with external environmental information to make potentially more accurate predictions on when the end of life of the cabin air filter will be reached and/or to discern the current state of the cabin air filter media. In this way, the systems of this disclosure may create a black-box that describes the vehicle's micro-environment, but allows for air quality input variables to make an accurate filter media end of life prediction.

In some examples, the systems of this disclosure may disregard (or reduce the importance of) in-vehicle sensed PM levels from the filter effectiveness score when the windows and/or sunroof are open in the vehicle. Having the windows or sunroof open allows unfiltered external air to move freely into the cabin and thereby decreases the accuracy of the measure of filter effectiveness. The filter media end-of-life modeling algorithm can be used to predict degradations in other cabin systems, because any drift in sensor data and/or prediction accuracies can be correlated to other systems. For instance, failure in weather seals or degradation in fan speed can be detected.

By ingesting some or all of the factors or factor combinations above, the systems of this disclosure may enable the trained model, when in the execution phase, to personalize lifetime predictions and filter effectiveness scores for a particular vehicle. By creating a map of these personalized predictions with a sufficiently large sample size, the systems of this disclosure may eventually build out a dataset that could provide an estimation for a vehicle without an air quality sensor system based solely on geographical travel data. In this way, the systems of this disclosure make it possible to provide an averaged prediction based on the amassed data set for expected filter lifetime and filter effectiveness over time that, although not as accurate as actually having a cabin air quality sensor system installed in the vehicle, are still greatly improved over a simple time schedule or vehicle miles traveled.

Some examples of this disclosure are directed to the utilization of various sensor types and/or sensor arrays distributed throughout a vehicle cabin or enclosed, mobile environment. These sensors/sensor arrays can detect a pressure differential or levels of one or more of various substances, odors, and/or chemicals in the in-cabin air. The sensor data can be correlated to in-cabin air quality or outdoor air quality and other cabin environment safety or comfort conditions such as particle or fume levels which would allow the cabin air quality monitoring system to respond through alerts or automated control of vehicle systems. In some examples, the systems of this disclosure may use groups of sensors to achieve higher sensitivity to the target. In some examples, the systems of this disclosure may combine data sets from different sensor types to derive enhanced air quality information or supplemental information about vehicle status.

In the past, furnace filters were primarily used to keep dust levels down in homes, and the idea of filtering air coming into a vehicle cabin was largely unaddressed until the 21st century. Despite unprecedented attention to outdoor air quality, cabin air filters remain one of the most neglected of the routine maintenance parts in vehicles. Vehicle manuals, repair shops, and online sources recommend drastically varying frequencies and symptoms by which to instigate cabin air filter replacement. While a vehicle manual may indicate that the cabin air filter should be replace every 10,000 miles, a service shop may recommend 15,000-30,000 miles for the same vehicle, while others may recommend replacing the cabin air filter every two oil changes.

Some online guides recommend replacing the cabin air filter when the user notices that he/she needs to increase the fan speed to what seems too great high to achieve the intended results, or in response to detecting persistent foul odor in the vehicle cabin. Some recommendations are qualified with vague guidelines such as to “adjust” the cabin air filter replacement schedule if the vehicle is driven on dirt roads or if the vehicle is used largely in hot and dry climates.

Even with all of the variability and ambiguity described above, cabin air filter replacement is still not administered using automated systems that monitor actual air quality and/or filter medium effectiveness in order to provide a sensor based measurement of filter life and a prediction of cabin air filter replacement schedule on an individualized per-vehicle basis. With a cabin air quality system integrated into a vehicle, as described with respect to some aspects of this disclosure, an operator can determine whether or not the vehicle's cabin air filter is performing as expected by the manufacturer, and may potentially see live data about cabin air quality to both inform safety of breathing in the vehicle as well as to make informed purchasing decisions related to the actual performance of any given cabin air filter in the vehicle.

Air quality monitoring is widely performed in both indoor and outdoor environments, and locations are often in highly populated areas such as on busy roads, city centers, schools, or hospitals, to determine pollution levels, provide trend data, and evaluate effectiveness of control strategies. Sensors may be built into a station that is designed to protect them from extreme environmental conditions where applicable. Home air quality monitoring devices are sized to fit on a desktop and typically measure levels of VOCs, smoke, pollen, mold, CO, and sometimes carbon dioxide. Air quality sensors may include PM sensors in which particles are optically counted or mass concentration is measured using scattered light signals. Gas phase sensing is achieved by passing air samples over electrochemical cells.

Monitoring cabin air quality in a vehicle cabin often calls for adjustment for and extra protection against temperature, humidity, and vibration extremes due to the mobility of the monitored environment and the typical outdoor settings. The systems described herein may potentially provide the advantage of simplified sensor design to determine cabin air filter efficacy and relative air quality. In this way, the systems of this disclosure allow for compact designs which may simplify the incorporation of robustness. Additional PM and gas sensors in multiple configurations may be integrated to provide supplemental or reinforcing data to inform or improve the in-cabin air quality measurement, in accordance with aspects of this disclosure.

This technology, when provided as a service providing real-time or near real-time air quality metrics, supports ongoing cabin air filter quality maintenance. While described primarily with respect to automobile cabins as an example, it will be appreciated that these systems are applicable to and beneficial to other types of vehicle cabins, and may be used with respect to aviation (aircraft cabins), agriculture (e.g. tractor cabins), commercial trucking, military (e.g., transportation vehicles, fighter vehicles, evac vehicles, etc.), commercial shipping (e.g., trans-oceanic shipping), enclosed boat or yacht cabins, etc.

By supporting sensor platforms for in-cabin air quality measurement, the systems of this disclosure may enable a notification or reporting system, and may help drive analysis methods that leverage machine learning and data analytics. These systems of this disclosure may also be beneficial in developing enhanced filtration media to extract various air born components from organic to inorganic components.

This disclosure identifies applicable hardware and useful analytes that the hardware can sense. The systems of this disclosure may add a unique value to the data these sensors produce when they are operated in the cabin air quality sensor system described herein, because the sensor measurements can be combined with contextual data collected from the vehicle state and sensed or ingested environmental data. The combination of these measurements analyzed in a new and powerful way can provide insights and enable use cases that would not be possible without the systems described herein.

Application of Sensor Types include: Filter life pressure sensors that may be applied to the cabin air filter and combined with cabin air quality data; Breathalyzer sensors (fuel cell or semiconductor sensor measuring the reaction to potassium dichromate (K2Cr2O7)) that may be tuned to detect alcohol levels in the cabin air; Ozone detection technology designed for disinfection and sterilization of rooms in buildings that may be modified and applied to the cabin environment for the same purpose; Ozone detectors that may also be used to determine if the cabin HVAC system is malfunctioning; or Photochromic optical sensors as used in personal UVR detection may be applied to measure UVA and UVB rays entering the cabin environment and data fed to the air quality monitoring system for additional metrics.

Application of sensor systems or arrays are described below. Different sensor types may be used together to form a sensor package that is unique in its use for monitoring and detection. For instance, if the system is configured to detect a trace amount of some VOC or gas, an array of sensors with different material types may be created based on their sensitivity to the target and interfering gases to effectively filter out the interfering gases. This technique may be applied in the vehicle environment. Another technique to discern the effectiveness of filtration and/or the source of a sensed analyte is to take delta measurements. In this case, measuring inside and outside of a vehicle with the same type of sensor can reveal several things depending on the state of the vehicle.

One advantage of the proposed system described above that enables this type of measurement is that the sensor system knows the status of the vehicle due to the ability to ingest vehicle data into the model. If the system has access to parameters such as window state, HVAC state, vehicle operational state, etc., then the system can apply and deduce one set of learnings through modeled output or another. Data may be used to enhance the cabin air quality measurement. For example, exhaust fume sensors could be placed both in the cabin and at the exhaust outlet.

Distributing sensing of a particular sensor in multiple places within the vehicle provides additional information about the source and local levels of a sensed analyte. Taking a common mode measurement from two duplicate sensors may help reduce noise and enable more accurate sensing in certain driving conditions. Sensors can also be intelligently enabled or disabled depending on vehicle state data to ensure relevant data is being collected. Using a sensor array could provide additional spatial resolution of a sensed analyte, or indicate directional flow of that analyte.

This disclosure also describes various embodiments of models that could be packaged and executed in the cabin air quality sensor systems described above. The purpose of these models is to enable a data-driven approach to give visibility into air quality conditions within vehicle cabins and outside of the vehicle cabins. Example models predict the end of life of cabin air filters, generate warnings with respect to potentially leaky cabin seals (weather stripping), and predict impending fan failure. Algorithms and decision trees are described herein that enable more advanced insights and unique combinations of data from a broad set of sources through algorithms deployed and integrated into a vehicle's infotainment system.

This disclosure describes several examples of how new insights can be derived when unique combinations of data are presented for processing by custom algorithms. These algorithms may be executed in the cloud (e.g., by the cloud-based monitoring system of FIG. 1) or be deployed in a containerized version (e.g., in a “black box” manner) into vehicles. The algorithms may be continually improved and deployed, thereby improving data precision provided by the air quality sensor systems of this disclosure on an ongoing basis.

One advantage provided by this system comes from combining various sensors together, processing the combined sensor data through an algorithm, and outputting new unique insights or derived data from those measurements that would not be possible without the unity/unification/synergistic operation of these disparate sensors (or subgroupings thereof). Examples of these data combinations include one or more of: combining window position data with indoor and outdoor PM counts to gauge filter effectiveness only when windows are up; combining scraped traffic congestion data, outdoor PM or pollution data, and in-vehicle sensor air quality data to determine whether vehicle is operating within EPA guidelines for pollution; or combining pressure data, vehicle miles traveled (VMT), filter performance, and environmental exposure across a set of ingested sample data to produce filter performance comparisons across many makes and models of products.

Other advantages come from designing applications that leverage those new data elements derived from the new combinations of data. Several examples of these applications/use cases are described below, and generally relate to one or more of the following: defining filter effectiveness based on relevant data points only; sensing failing vehicle components related to cabin air quality (blower fan, door seals, fan controls, baffles, etc.); detecting exhaust leaks; product comparisons; generating product claims for performance; or using data to design new filter types to address areas or driving profiles with poor filter life or performance.

The systems of this disclosure may generate these data streams of this disclosure and enable these applications of this disclosure by operating one or more complex models and/or algorithms either in the cloud or in a secured deployed container in the vehicle's computing infrastructure (e.g., computing infrastructure linked to or implemented in the infotainment system). Additionally, the systems of this disclosure may leverage different types of model strategies, depending on the contemplated goals of the effort, and the continuity of data availability. In some examples, the systems of this disclosure may utilize time series models for forecasting, e.g. based on a complex set of time series data points. In these examples, by considering how sensor values and delta sensor values change over time, the systems of this disclosure may measure/quantify/estimate cabin air filter effectiveness and predict the end of life for a cabin air filter. If time series data is not available, the systems of this disclosure may implement an appropriately trained model to derive a predicted end of life of the cabin air filter from a single measurement.

Described below is an example algorithm of this disclosure for taking in base sensor data, refining the ingested data, and combining the refined data with other refined data values to satisfy one or more functional use cases that are not otherwise possible without the capabilities of a model trained in this particular way with one or more of the data combinations described above. In the execution phase, this algorithm ingests a set of environmental data points along with indoor (e.g., in-cabin) air quality data points and vehicle data into a trained machine learning model and outputs a filtration quality score assigned only using that one set of data (rather than looking at performance trends over time).

The systems of this disclosure may then execute another algorithm that takes the single filtration quality score and vehicle parameters (e.g., one or more of vehicle make, model, fan speed and HVAC settings at time of measurement, etc.) and derive a prediction for amount of filter life remining. In some examples the prediction may be expressed as a percentage value, a time value, or in other ways.

If data such as one or more of the average daily or weekly VMT, other driving conditions, and/or driver preferences including minimum filter performance tolerances are added to the prediction algorithms and evaluated on another model, the systems of this disclosure may derive an individualized estimate for what date the cabin air filter should be replaced.

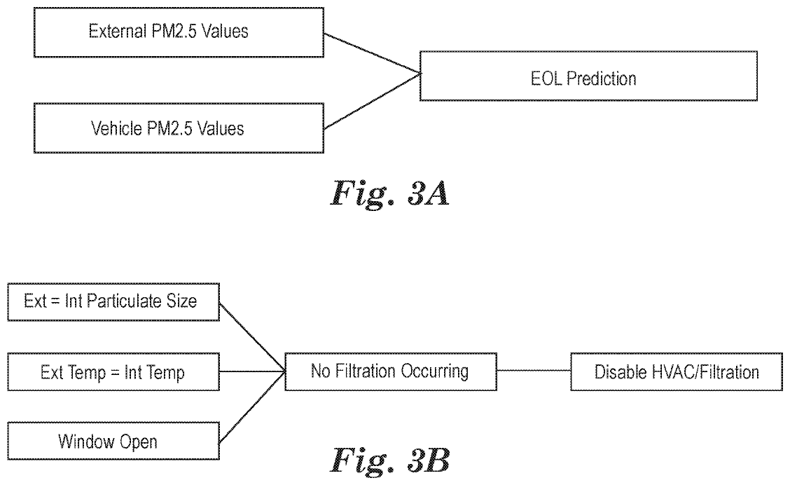

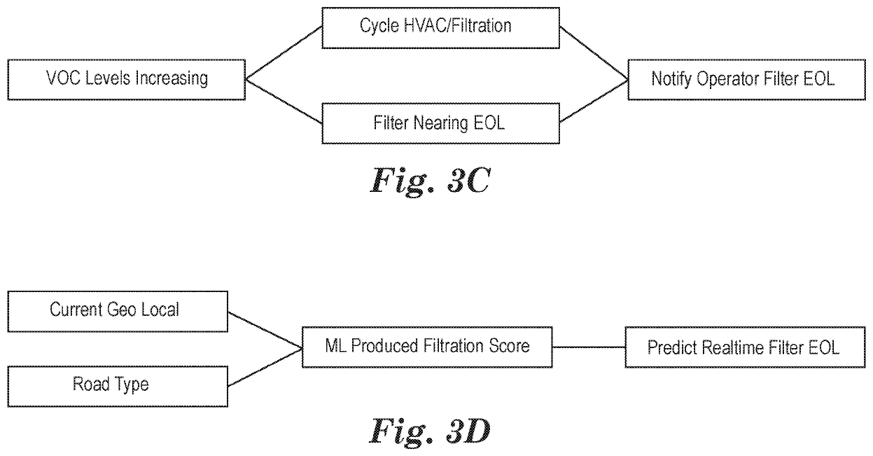

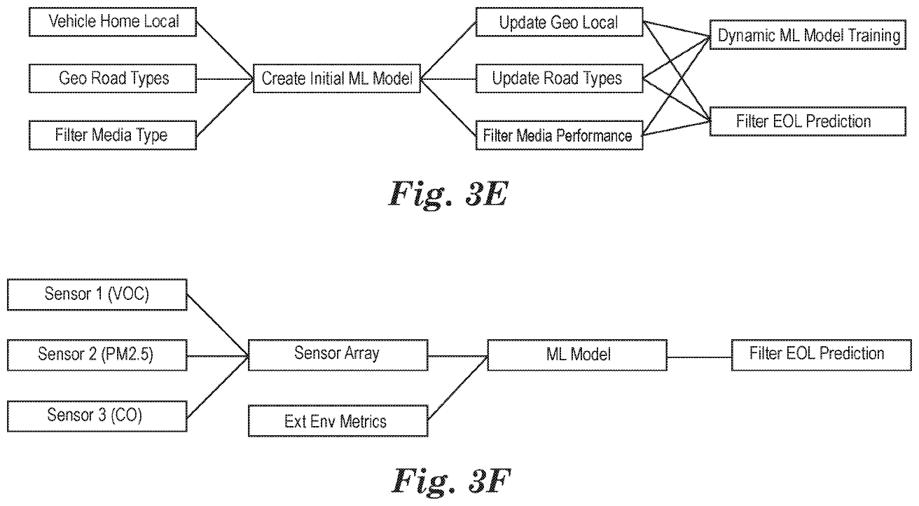

FIGS. 3A-3F are example decision trees for deriving different conclusions based on combinations of measured sensor data, vehicle configuration data and external data streams. The decision trees shown in FIGS. 3A-3F are examples of combining different sensor data to derive new data elements either for input into further systems, for training additional models, or/and for prompting feedback to vehicle owner/operators.

FIG. 3A illustrates a comparison between internal and external models, in accordance with aspects of this disclosure.

FIG. 3A illustrates a comparison between internal and external models, in accordance with aspects of this disclosure.

FIG. 3B illustrates a combination of vehicle(s) metrics with vehicle state information for machine learning-based analysis to control one or more vehicle systems.

FIG. 3C illustrates a notification mechanism that notifies a vehicle operator that the cabin air filter has reached its end of life.

FIG. 3D illustrates real-time end-of-life predictions for cabin air filters based on geolocation information and road types (e.g., dirt, gravel, paved, and so on).

FIG. 3E illustrates seeding for an initial model and dynamically updating the model for improved end-of-life predictions for cabin air filters.

FIG. 3F illustrates combining sensors to create a unique acquisition array along with external air quality metrics to create a machine learning-based model that provides accurate or relatively accurate end-of-life predictions for cabin air filters.

In this way, aspects of this disclosure are directed to systems that leverage a suite of sensors, environmental conditions, and vehicle system data to create a personalized recommendation on when to replace a cabin air filter and to inform vehicle operators/occupants/owners of the effectiveness of the cabin air filters. Dynamic models described herein enable systems to provide these data-driven recommendations and effectiveness scores. The dynamic models of this disclosure may be tested using various data, such as real-world data, for additional refinement and training.

One of the advantages of using data-driven approaches of this disclosure to prompt cabin air filter replacement rather than a one-dimensional mileage-based or time-based schedule is that cabin air filter quality becomes apparent relatively quickly or potentially even immediately. By observing a cabin air filter's effectiveness decline over time and comparing that performance to other makes or models of cabin air filters compatible with a specific vehicle, a direct correlation may be drawn, with certain levels of granularity, between driving and storage conditions differences in filter quality and measured filter lifetime. Data that is limited to a purely schedule-based cabin air filter replacement scheme makes it difficult to ascertain how effective a previously installed cabin air filter was over the duration of that schedule. The data-driven techniques of this disclosure can set apart high quality filter manufacturers or filter models from poorer-performing manufacturers or models.

Additionally, models can be developed in accordance with this disclosure to recommend specific filters which have proven to have higher effectiveness/efficacy or longer lifetime under similar driving conditions and/or environmental conditions as the candidate vehicle. Another technique consistent with this disclosure to analyze the effectiveness of filtration and/or the source of a sensed analyte to obtain delta measurements for further use. In this case, measuring metrics inside and outside of a vehicle with the same type of sensor can reveal several factors depending on the state of the vehicle. One advantage of some of the system configurations described herein is that the systems may enable this type of delta measurement, thereby providing the systems with information indicating the status of the vehicle due to the ability to ingest vehicle data into the model. If parameters included in the training data (or potentially used as inputs in the execution phase) include one or more of window state, HVAC state, vehicle operational state, etc., then the trained model can apply and deduce one set of learnings through modeled output or another.

In some aspects, this disclosure is directed to an in-vehicle cabin air quality system that is equipped to detect one or more of foul odors, illegal substances, ozone detection, VOCs such as carbon monoxide, carbon dioxide, gasoline vapors, benzene, toluene, 1,3-butadiene, xylene, formaldehyde, ethylene glycol, or other contaminants such as vehicle exhaust, pollen, sulfur dioxide, nitrogen dioxide; particle pollution (PM), viral and/or bacterial biological components, etc. The system may correlate this data with external air quality metrics, and may factor in correlations with sun intensity, including UV levels, and/or atmospheric conditions.

With these types air quality information, the systems of this disclosure may initiate or recommend different vehicle actions to be taken. Examples including preventing vehicle operation, generating notification of impending vehicle system failures, providing input to vehicle systems such as the electronic control unit (ECU) for improved performance and economy, providing operator notification of impending system maintenance, etc.

In these aspects, this disclosure is directed to systems that, when deployed, improve the wellbeing of vehicle occupants by monitoring cabin air quality, controlling the cabin air quality through filtration and HVAC automation, and providing occupant feedback on the condition of the environmental air quality within the vehicle cabin. In many real-life scenarios, the air quality inside a vehicle is worse than the outside air. The pollutants present in the in-cabin air may increase potential risk factors for cancer, heart disease, immune disorders, blood disorders, and various other illnesses. Reducing the level of these contaminants in the vehicle cabin or providing air quality feedback that instigates preventive measures or remediation actions can lead to an improved state and higher degree of occupant wellbeing.

In addition to improving vehicle occupant wellbeing, the systems of this disclosure may provide notifications on vehicle system conditions based on distinct odors, such as electrical failures due to electrical shorts or burning wires. The notification aspects of this disclosure may provide improved vehicle performance and efficiency based on additional air quality metrics, by prompting preventative or remediation actions. The systems of this disclosure may, in some instances, analyze air quality using a combination of in-cabin data and external environment air quality metrics for additional modeling.

With a cabin air quality system of this disclosure integrated into a vehicle, an operator can discern whether the cabin air filter is performing as expected/promised by the manufacturer. The systems of this disclosure may also enable the operator to receive live data or near-live data pertaining to cabin air quality to both inform safety of breathing in the vehicle as well as make informed filter replacement decisions related to the actual performance of any given cabin air filter in the vehicle. These aspects of the disclosure potentially address a new technology space by developing a sensor platform for air quality measurement with a notification and/or reporting system. These systems may lend themselves to developing analysis methods that could leverage machine learning and data analytics, and potentially to developing enhanced filtration media to extract various airborne components ranging from organic to inorganic components.

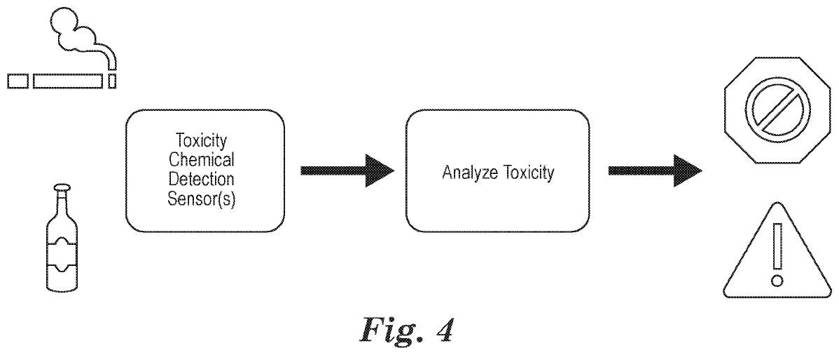

FIG. 4 is a block diagram illustrating a mechanism to detect illegal substances or driver impairment based on chemical detection that warns the occupants or inhibits the vehicle from moving through integration with vehicle's computing systems. With one or more sensors deployed inside the vehicle's cabin to detect airborne compounds, the systems of this disclosure may determine the absence or presence (and in some cases, an estimated concentration of) airborne compounds that are deemed either illegal or a risk of impairing the driver from being able to safely operate the vehicle.

With the sensors deployed in the cabin at positions for optimal detection, the sensors may relay data to a computing resource where a machine learning model or similar algorithm analyzes the data for both predefined compounds and for toxicity levels. The computing resource may cause the results to be displayed to the operator via a vehicle display unit (e.g, a dashboard control and/or via the infotainment HMI or speaker system). Optionally, the computing resource may feed to the vehicle control systems one or more instructions to disable the vehicle or discrete subsystems thereof. In some cases, the computing resource may log this type of data for future analysis or training refinement.

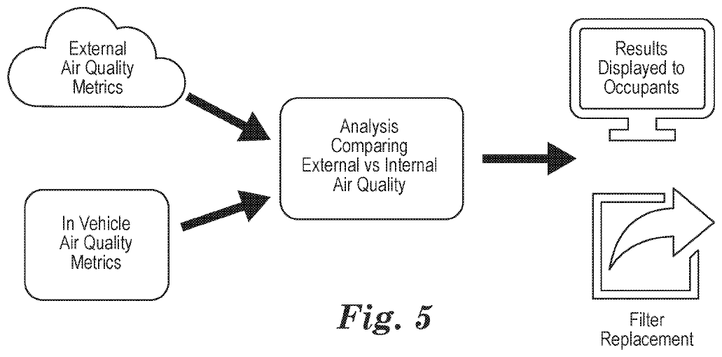

FIG. 5 illustrates a base use case of delta air quality determination, in accordance with aspects of this disclosure. The systems of this disclosure may implement the techniques related to FIG. 5 by scraping data (e.g., from web sources or from other sources) indicative of outside particulate numbers and comparing the outside particulate information to in-cabin particulate information provided by the sensors deployed in the cabin. One or more sensors deployed inside the vehicle's cabin may detect airborne compounds for factors such as particulate size, allergens, dust, smoke, and other airborne pollutants/contaminants/irritants. When sensors are deployed in the cabin in such a way as to perform optimal detection, the data from the sensors and from an external air quality resource are relayed to a computing resource of this disclosure. The computing resource may execute a machine learning model or similar algorithm that compares and contrasts the information to output one or more of current air measurements, predictions for future air quality levels, predictions on cabin air filtration media end of life, and/or analysis on the current cabin air filter performance.

The computing resource may implement techniques of this disclosure to cause the results to be output to users via in-vehicle HMIs, such as an infotainment display, the in-cabin speaker system, a dashboard control (e.g., as an indicator light or icon on the vehicle's dashboard), etc. In some examples, the computing resource of this disclosure may relay the results to a mobile device such as a smartphone, to be output through the vehicle manufacturer's mobile phone application or web portal, or via a cabin air filter monitoring application. If the filter media is determined to be at its end of life, the computing resource of this disclosure may also communicate options for replacement such as scheduling an appointment with the dealer for servicing, ordering new media for do-it-yourself (DIY) replacement, or options or recommendations for filter media specific to the user's environmental conditions (e.g., current and predicted, based on ML predictions).

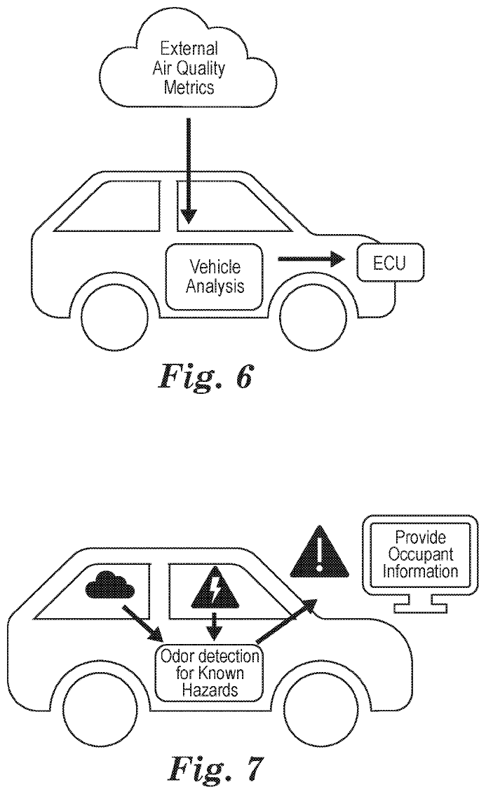

FIG. 6 illustrates aspects of this disclosure by which systems may optimize vehicle tuning parameters in the vehicle's electronic control unit (ECU) based on sensed conditions in vehicle and scraped from outside of the vehicle. Data from a vehicle-external air quality service are relayed to a computing resource. The computing resource executes a machine learning model or similar algorithm in accordance with this disclosure to analyze the outside air quality for metrics that are not currently available to the vehicle's ECU. These metrics may include data such as, but not limited to, PM size, smoke and smog particulates, water vapor levels, ozone; carbon monoxide, carbon dioxide, and nitrogen dioxide. The computing resource may feed the analysis of this data would to the vehicle's ECU for improved filtration performance and/or emission performance based on current environmental conditions.

FIG. 7 illustrates techniques of this disclosure that enable in-cabin odor sensing. According to the techniques shown in FIG. 7, a sensor and computing infrastructure of this disclosure may detect odors indicating any decaying matter (e.g., forgotten food, animal in grill, etc.) or other known hazards (electrical fires, etc.) and notify occupants of the detected conditions. One or more sensors deployed inside the vehicle's cabin may detect airborne compounds for odors related to decaying organic material and other known hazards like electrical fires. The sensors may be deployed in the cabin at positions and orientations (and/or relative positions/orientations) for optimal detection performance.

A computing resource of this disclosure may consume the data produced by the sensors, and may execute a machine learning model or similar algorithm that would compare and contrast the information using training data. The computing resource of this may implement techniques of this disclosure to cause the results to be output to users via in-vehicle HMIs, such as an infotainment display, the in-cabin speaker system, a dashboard control (e.g., as an indicator light or icon on the vehicle's dashboard), etc. In some examples, the computing resource of this disclosure may relay the results to a mobile device such as a smartphone, to be output through the vehicle manufacturer's mobile phone application or web portal, or via a cabin air filter monitoring application. In some cases, the computing resource may send this type of information to the vehicle manufacturer, cabin air filter manufacturer, or dealer for recall notifications and service scheduling.

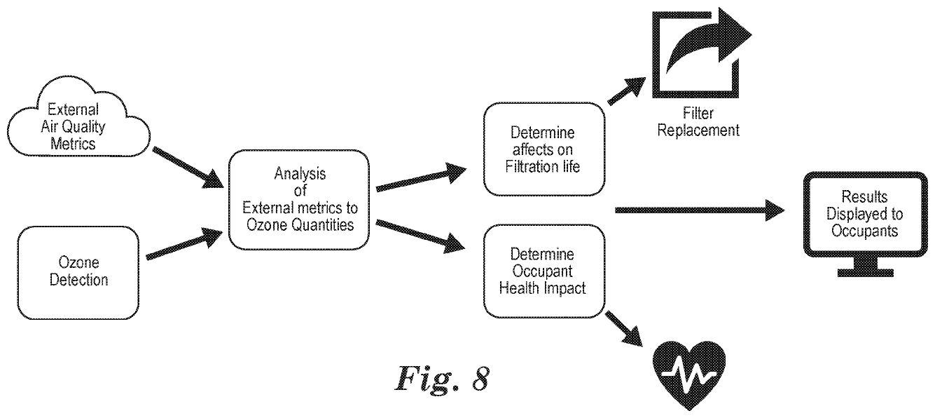

FIG. 8 illustrates aspects of this disclosure directed to in-cabin ozone detection. The techniques of FIG. 8 may be used in conjunction with determination of longevity of materials (e.g.

plastics). For example, the techniques of FIG. 8 may be used to determine whether/when or not cabin air filter media will break down due to ozone or will be otherwise impacted in terms of lifetime/effectiveness due to ozone. As another example, the techniques of FIG. 8 may be applied for measuring degassing of interior materials and to thereby determine/improve the health impact on the cabin occupants.

One or more sensors deployed inside the vehicle's cabin may detect ozone levels. The sensors may be deployed in the cabin for optimal detection in terms of their positioning and/or orientation. A computing resource of this disclosure may consume data from the sensors and from an external air quality resource. The computing resource may execute a machine learning model or similar algorithm of this disclosure that compares and contrasts the information to output one or more of current air measurements, predictions for future air quality levels, predictions on cabin air filtration media end of life, analysis on the current cabin air filtration performance, and/or impact on occupant health and wellbeing.

The computing resource may also perform additional analysis that determines the impact of ozone on filter media and effects on cabin materials for byproducts such as outgassing of plastics. The computing resource of this may implement techniques of this disclosure to cause the results to be output to users via in-vehicle HMIs, such as an infotainment display, the in-cabin speaker system, a dashboard control (e.g., as an indicator light or icon on the vehicle's dashboard), etc. In some examples, the computing resource of this disclosure may relay the results to a mobile device such as a smartphone, to be output through the vehicle manufacturer's mobile phone application or web portal, or via a cabin air filter monitoring application. In some implementations, the computing resource may relay the information (or portions thereof) to manufacturers for product research and development for further use.

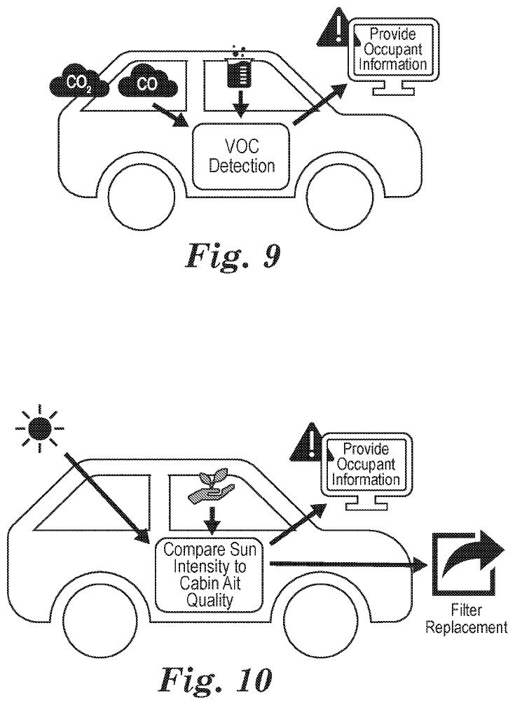

FIG. 9 illustrates techniques of this disclosure for measuring in-cabin presence of VOCs and other parameters (carbon monoxide, etc). The techniques shown in FIG. 9 enable the systems of this disclosure to expand on a few salient VOCs like carbon monoxide, carbon dioxide, and any other evaporation vapors that might emanate from gasoline combustion and be present in the vehicle cabin. One or more sensors deployed inside the vehicle's cabin may detect airborne compounds for VOCs including one or more of carbon monoxide, carbon dioxide, gasoline vapors, benzene, toluene, 1,3-butadiene, xylene, formaldehyde, and/or ethylene glycol. In some cases, the sensors may detect vehicle exhaust, pollen, sulfur dioxide, nitrogen dioxide related to decaying organic material and contaminants associated with other known hazards like electrical fires.

The sensors may be deployed in the cabin for optimal detection, such as in terms of their positioning and/or orientation. Data from the sensors may be relayed to a computing resource which may execute a machine learning model or similar algorithm of this disclosure to compare and contrast the information to trained data on known VOCs. The computing resource of this may implement techniques of this disclosure to cause the results to be output to users via in-vehicle HMIs, such as an infotainment display, the in-cabin speaker system, a dashboard control (e.g., as an indicator light or icon on the vehicle's dashboard), etc. In some examples, the computing resource of this disclosure may relay the results to a mobile device such as a smartphone, to be output through the vehicle manufacturer's mobile phone application or web portal, or via a cabin air filter monitoring application. In some implementations, the computing resource of this disclosure may send this information (or discrete portions thereof) to a manufacturer or dealer for recall notifications and/or service scheduling.

FIG. 10 illustrates techniques of this disclosure related to providing correlation of sun intensity (e.g., ultraviolet light intensity) to in-cabin air quality to provide occupant air quality assessment and cabin air filtration recommendations. One or more sensors deployed inside the vehicle's cabin may detect sun intensity levels such UV intensity. The sensors may be deployed in the cabin for optimal detection, in terms of their positions and/or orientations. Data from the sensors may be relayed to a computing resource which may execute a machine learning model or similar algorithm of this disclosure to compare and contrast the information to trained data on known sun intensity levels.

The computing resource of this may implement techniques of this disclosure to cause the results to be output to users via in-vehicle HMIs, such as an infotainment display, the in-cabin speaker system, a dashboard control (e.g., as an indicator light or icon on the vehicle's dashboard), etc. In some examples, the computing resource of this disclosure may relay the results to a mobile device such as a smartphone, to be output through the vehicle manufacturer's mobile phone application or web portal, or via a cabin air filter monitoring application. In some implementations, the computing resource of this disclosure may send this information (or discrete portions thereof) to a manufacturer or dealer for recall notifications and/or service scheduling.

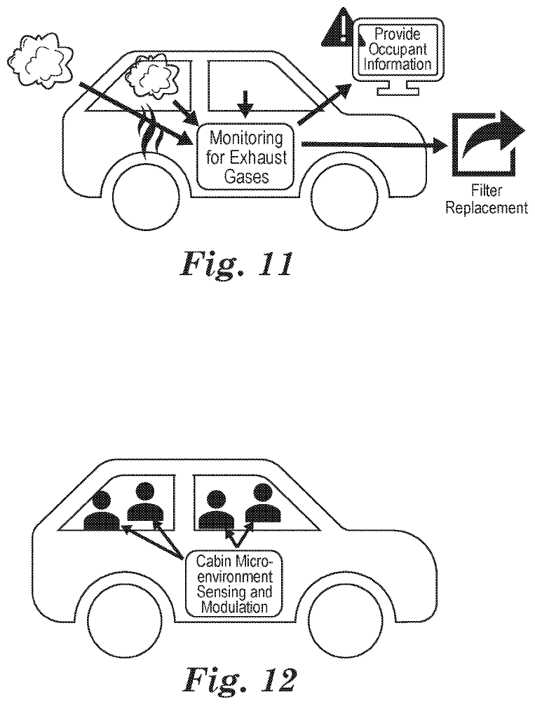

FIG. 11 illustrates aspects of this disclosure related to exhaust sensing. The exhaust sensing aspects of FIG. 11 enable systems of this disclosure to sense leaks from the vehicle's exhaust system into the vehicle cabin or from other exhaust sources near the vehicle into the cabin of the candidate vehicle. One or more sensors deployed inside the vehicle's cabin may detect exhaust from both inside and outside the vehicle, with the sensors being deployed in the cabin for optimal detection, such as by way of their positions and/or orientations. Data from the sensors may be relayed to a computing resource which may execute a machine learning model or similar algorithm of this disclosure to compare and contrast the information to trained data on known exhaust metrics.

The computing resource of this may implement techniques of this disclosure to cause the results to be output to users via in-vehicle HMIs, such as an infotainment display, the in-cabin speaker system, a dashboard control (e.g., as an indicator light or icon on the vehicle's dashboard), etc. In some examples, the computing resource of this disclosure may relay the results to a mobile device such as a smartphone, to be output through the vehicle manufacturer's mobile phone application or web portal, or via a cabin air filter monitoring application. In some implementations, the computing resource of this disclosure may send this information (or discrete portions thereof) to a manufacturer or dealer for recall notifications and/or service scheduling. In some instances, the computing resource of this disclosure may use or enable other systems to use this information to inhibit the vehicle operation for the wellbeing and safety of the occupant(s).

FIG. 12 illustrates aspects of this disclosure that enable systems to automate air quality measures in multiple zones within a vehicle cabin to provide micro-environment improvements in air quality in order to achieve a normalized and improved cabin environment for the vehicle occupant(s). One or more sensors may be deployed inside the vehicle's cabin to detect micro-environment air quality, with the sensors being deployed in the cabin for optimal detection, such as by way of their positioning and/or orientations. Data from the sensors may be relayed to a computing resource, which may execute a machine learning model or similar algorithm of this disclosure to compare and contrast the information to trained data on known air quality metrics. The computing resource may feed the results of the executed model to the vehicle's HVAC and filtration system for zonal improvements. In this way, aspects of this disclosure may normalize the air quality throughout the vehicle cabin to improve the health and wellbeing of the occupant(s).

According to some aspects of this disclosure, computing resources may integrate vehicle data and metrics with in-home air quality monitoring data. For users with multiple smart air quality monitoring systems (e.g., multiple vehicles or a vehicle system in addition to the home system), the integration techniques of this disclosure may provide a common application environment for investigating details and ensuring the appropriate filter choice for these multiple environments. To enable integration, the cloud-based monitoring system of this disclosure may store data from the vehicle may pair with an integrated web portal or smartphone application, thereby providing users combined, consolidated, integrated, air quality and filter data via a single interface. Integrating with a smartphone application or web portal would also provide a mechanism for vehicle owners to look at historical data relating to their vehicle's filter life and potentially other more technical metrics that might be too complicated, detailed, or granular to display via a vehicle dashboard or in-vehicle user interface.

According to some aspects of this disclosure, systems may utilize vehicles (e.g., electric vehicles) to filter air in an environment such as a garage or other enclosed space, or in the areas surrounding buildings that emanate air pollutants. Often, garages and other enclosed workspaces do not have adequate ventilation, and sometimes no HVAC system at all. These also tend to be the spaces that contain the most chemicals and VOCs in homes and/or workplaces. According to aspects of this disclosure, a vehicle equipped with air filtering media (e.g., an electric or non-polluting or PZEV) could function as a filter for such a space.

Systems of this disclosure may enable manual activation of this functionality via a setting entered through a vehicle HMI, or may engage automatically when harmful substances or high (e.g., as determined using a threshold) particulate or VOC levels are detected by the sensor hardware deployed in the vehicle. In these examples, the systems of this disclosure provide cleaner and safer air in these enclosed environments. If integrated with any smartphone application or other digital media, the vehicle sensor system may notify users of air quality concerns in or around the vehicle.

In another example, the vehicle may output (e.g., via display, sound, or both) warnings or other alerts upon entry into proximity of the vehicle. The vehicle could also convey this information to a person outside of the vehicle utilizing one of the available sensor modalities (e.g., flashing lights, sounding horn, push notifications, etc.) to alert that safety thresholds or other triggered events are present in the space surrounding the vehicle.

Some examples of this disclosure enable the implementation of a dynamic cabin air freshener. Air fresheners in vehicles are sometimes reported by users as being overpowering and offensive. Computing systems of this disclosure may dynamically dispense the air freshener only when needed (e.g., in response to the odor detection techniques of this disclosure described with respect to FIG. 7), or metering the freshener dispensation to keep the freshener level (as noticed via smell) to a subtle or desired magnitude to improve the cabin air quality experience of the occupant(s).

If certain particles or odors are detected in the cabin of the vehicle using one of the sensors described herein, the systems of this disclosure may dispense or adjust the presence or magnitude of an air freshener or odor neutralizer. In some examples, the systems of this disclosure may select from or custom-combine between a multitude of air freshener scents (or subset(s) thereof) intelligently by the vehicle based on a variety of parameters (e.g., user preference, selecting the best fit to neutralize a recently detected odor rather than cover up, applying a machine learning algorithm to predict the best fragrance or combination, etc.). In these examples, the systems of this disclosure may provide optimal freshening of the air while not overpowering the vehicle occupants while improving on existing in-cabin air freshening options.

In some examples, aspects of this disclosure enable systems to integrate cabin air quality measurements to personal health tracking devices. More and more individuals are tracking health and health data through smart watches and smart devices. Many cellular operating systems have a health and wellness application that can link data from many sources. A vehicle equipped with an air quality assessment system described herein may provide exposure levels for any tracked analyte or compound to the health application to provide the user with a more complete picture of respiratory and general health based on these data and other collected sensor data. In some such examples, the vehicle may also monitor the environments the user is near, and collect and report that information as part of this health monitoring functionality package.

Devices and systems of this disclosure may include, in addition to processors or processing circuitry, various types of memory. Memory devices or components of this disclosure may include a computer-readable storage medium or computer-readable storage device. In some examples, the memory includes one or more of a short-term memory or a long-term memory. The memory may include, for example, RAM, DRAM, SRAM, magnetic discs, optical discs, flash memories, or forms of EPROM, or EEPROM. In some examples, the memory is used to store program instructions for execution by processors or processing circuitry communicatively coupled thereto. The memory may be used by software or applications running on various devices or systems to temporarily store information during program execution.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk

(DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, overtime, change (e.g., in RAM or cache).

Various examples have been described. These and other examples are within the scope of the following claims.

1. A cabin air quality monitoring system comprising:
a communications interface configured to receive snapshot information representing in-cabin air quality of a vehicle;
a memory configured to store the snapshot information received by the communications interface; and
processing circuitry configured to:
batch the snapshot information stored to the memory to form batched snapshot information;
execute, using the batched snapshot information as an input, a trained machine learning (ML) model to obtain a model output that includes cabin air filter replacement information; and
transmit, via the communications interface, the model output to computing hardware of the vehicle.

2. The cabin air quality monitoring system of claim 1, wherein the processing circuitry is further configured to perform one or more of level normalization, unit conversion, or translation on the batched snapshot information to form preprocessed snapshot information, and wherein to execute the trained ML model, the processing circuitry is configured to execute the trained ML model using the preprocessed snapshot information as the input.

3. The cabin air quality monitoring system of claim 1, wherein the processing circuitry is further configured to:
determine that the cabin air filter replacement information of the model output indicates that the vehicle is due for cabin air filter replacement; and
transmit, via the communications interface, cabin air filter replacement data to the computing hardware of the vehicle.

4. The cabin air quality monitoring system of claim 1, wherein the processing circuitry is further configured to transmit, via the communications interface, the model output to a mobile computing device.

5. The cabin air quality monitoring system of claim 1, wherein the snapshot information comprises a comparative score between the in-cabin air quality of the vehicle and outdoor air quality at one or more locations associated with the vehicle.

6. The cabin air quality monitoring system of claim 1, wherein the model output further includes toxicity information with respect to the in-cabin air quality of the vehicle.

7. The cabin air quality monitoring system of claim 1, wherein the in-cabin air quality information includes micro-environment air quality information associated with respective positions of one or more passengers within the vehicle.

8. The cabin air quality monitoring system of claim 1, wherein the in-cabin air quality information includes volatile organic compound (VOC) information with respect to the in-cabin air quality of the vehicle.

9. The cabin air quality monitoring system of claim 1, wherein the in-cabin air quality information includes vehicle exhaust information.

10. The cabin air quality monitoring system of claim 9, wherein the vehicle exhaust information includes an in-cabin vehicle exhaust measurement.

11. The cabin air quality monitoring system of claim 10, wherein the vehicle exhaust information includes a comparative score between the in-cabin vehicle exhaust measurement and an outdoor vehicle exhaust measurement.

12. The cabin air quality monitoring system of claim 1, wherein the in-cabin air quality information indicates an ultraviolet (UV) light intensity within a cabin of the vehicle.

13. The cabin air quality monitoring system of claim 1, wherein the in-cabin air quality information indicates an ozone level within a cabin of the vehicle.

14. An air quality monitoring system comprising:
an interface configured to receive in-cabin air quality information associated with a vehicle;
a memory in communication with the interface, the memory being configured to store the in-cabin air quality information associated with the vehicle; and
processing circuitry in communication with the memory, the processing circuitry being configured to determine, based on the in-cabin air quality information associated with the vehicle, an end-of-life prediction for a cabin air filter of the vehicle.
